(19) United States
(12) Patent Application Publication
(10) Pub. No.: US 2025/0249723 A1
(43) Pub. Date: Aug. 7, 2025

(54) COOLING STRUCTURE FOR VEHICLE

(71) Applicant: TOYOTA JIDOSHA KABUSHIKI KAISHA, Toyota-shi (JP)

(72) Inventor: Eiji ISHIKAWA, Okazaki-shi (JP)

(73) Assignee: TOYOTA JIDOSHA KABUSHIKI KAISHA, Toyota-shi (JP)

(21) Appl. No.: 18/960,284

(22) Filed: Nov. 26, 2024

(30) Foreign Application Priority Data
Feb. 2, 2024 (JP) 2024-015083

(51) Int. Cl. B60H 1/00

(52) U.S. Cl. CPC B60H 1/00664; B60H 1/00564

(57) ABSTRACT

The cooling structure includes a first intake opening provided at a front end portion of the vehicle, a second intake opening provided at another portion except the front end portion of the vehicle, and a radiator disposed at a vehicle rear side of the first intake opening and cooled by heat exchange with air. Further, the cooling structure includes a first duct portion disposed between the first intake opening and the radiator and supplying air introduced from the first intake opening to the radiator, and a second duct portion branched from the first duct portion and connecting the second intake opening and the first duct portion, and supplying the air introduced from the second intake opening to the first duct portion.

### CROSS-REFERENCE TO RELATED APPLICATION

This application claims priority to Japanese Patent Application No. 2024-015083 filed on Feb. 2, 2024, incorporated herein by reference in its entirety.

### BACKGROUND

### 1. Technical Field

The present disclosure relates to cooling structures for vehicles.

### 2. Description of Related Art

Japanese Unexamined Patent Application Publication No. 2013-107469 (JP 2013-107469 A) discloses a structure for introducing air into an air-cooled heat exchanger from a first inlet provided at the front end of a vehicle.

### SUMMARY

In the technique described in JP 2013-107469 A, however, the first inlet port has a large opening area in order to introduce a sufficient amount of air into the heat exchanger. This configuration has room for improvement because it has many restrictions on design of the vehicle end.

In view of the above, it is an object of the present disclosure to provide a cooling structure for a vehicle that can reduce restrictions on design of the vehicle front end.

A cooling structure for a vehicle according to claim 1 includes:
a first intake opening provided at a vehicle front end;
a second intake opening provided in a different portion other than the vehicle front end;
a heat exchanger that is disposed rearward of the first intake opening in a vehicle front-rear direction and that is cooled by heat exchange with air;
a first duct portion that is disposed between the first intake opening and the heat exchanger and that supplies air introduced from the first intake opening to the heat exchanger; and
a second duct portion that branches off from the first duct portion, that connects the second intake opening and the first duct portion, and that supplies air introduced from the second intake opening to the first duct portion.

In the cooling structure for the vehicle according to claim 1, for example, the air flow introduced into the first duct portion through the first intake opening provided at the vehicle front end is guided to the heat exchanger as cooling air when the vehicle travels or by operating a fan. The air flow introduced into the second duct portion through the second intake opening provided in the different portion other than the vehicle front end merges into the first duct portion, and is guided to the heat exchanger as cooling air. The second duct portion branches off from the first duct portion, so that the amount of air that is supplied to the heat exchanger through the first duct portion can be increased. Therefore, the cooling efficiency of a main cooling channel can be effectively increased, which makes it easier to reduce the opening area of the first intake opening. It is therefore possible to reduce restrictions on design of the vehicle front end.

According to a cooling structure for a vehicle of claim 2, in the configuration of claim 1, the second intake opening may be provided in a cowl portion disposed between a rear end of a hood and a front windshield, or in an indoor air-conditioning duct connected to the cowl portion.

In the cooling structure of claim 2,

the second intake opening is provided in the cowl portion disposed between the rear end of the hood and the front windshield, or in the indoor air-conditioning duct connected to the cowl portion.

The cowl portion and the indoor air-conditioning duct are conventionally provided in an existing vehicle as channels for introducing outside air into a vehicle cabin. Therefore, for example, an existing opening for introducing outside air can be used as the second intake opening. This configuration requires less change in vehicle body, and the second intake opening can be easily implemented.

According to a cooling structure for a vehicle of claim 3,

in the configuration of claim 1 or 2, the second duct portion may be connected to a side surface in a vehicle width direction of the first duct portion.

In the cooling structure of claim 3, the second duct portion is connected to the side surface in the vehicle width direction of the first duct portion. This configuration allows the second duct portion to be disposed to the side of the heat exchanger, which eliminates the need to secure a space for placing the second duct portion in the upper space in a power unit chamber. Accordingly, it is possible to adopt a design of a vehicle body with a low hood, which can reduce restrictions on the design of the vehicle front portion including the hood.

According to a cooling structure for a vehicle of claim 4, in the configuration of claim 1 or 2, the cooling structure may further include:
a fan that is provided rearward of the heat exchanger in the vehicle front-rear direction, and that discharges the air supplied to the heat exchanger via the first duct portion toward a rear of the vehicle; and
a flap portion configured to open and close a connection opening of the first duct portion that is connected to the second duct portion.

The flap portion may be configured to open when a pressure in the first duct portion becomes negative with respect to a pressure in the second duct portion by operation of the fan.

In the cooling structure of claim 4, the fan is provided rearward of the heat exchanger in the vehicle front-rear direction, and the air supplied to the heat exchanger via the first duct portion is discharged toward the rear of the vehicle after heat exchange. The connection opening of the first duct portion is connected to the second duct portion, and the first duct portion is provided with the flap portion configured to open and close the connection opening. The flap portion is configured to open when the fan is operated, and is configured to close when the fan is stopped. In other words, when the fan is stopped, the heat exchanger can be cooled by the air introduced from the first intake opening. When the fan is operated, the heat exchanger can be cooled by the air introduced from the first intake opening and the second intake opening. Accordingly, when it is necessary to increase the volume of cooling air, such as when sufficient running wind cannot be obtained because the vehicle is stopped etc. or when the fan is operated because heat is generated by an object to be cooled, it is possible to increase the volume of cooling air. On the other hand, when sufficient running wind is obtained because the vehicle is traveling etc. it is possible to reduce a decrease in aerodynamic performance during traveling by stopping introduction of air from the second duct portion.

Since the flap portion can be opened by the pressure difference between the first duct portion and the second duct portion, the flap portion can be opened and closed without using an electric actuator etc. Therefore, power consumption of the vehicle can be reduced.

According to a cooling structure for a vehicle of claim 5, in the configuration of claim 1 or 2, an object to be cooled by the heat exchanger may be connected to the heat exchanger via a cooling medium pipe, and the object to be cooled may be a battery mounted on the vehicle.

In the cooling structure of claim 5, the heat exchanger is connected to the battery mounted on the vehicle via the cooling medium pipe. Therefore, it is possible to reduce restrictions on the design of the vehicle front end while improving the cooling efficiency of the battery by the heat exchanger.

As described above, the cooling structure for the vehicle according to the present disclosure can reduce restrictions on the design of vehicle front portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a front portion of a vehicle showing a cooling structure according to the present embodiment;

FIG. 2 is a perspective view of a first duct portion constituting the cooling structure according to the present embodiment;

FIG. 3 is a cross-sectional view of the first duct portion taken along III-III of FIG. 2;

FIG. 4 is a block-diagram illustrating a hardware-configuration of a cooling ECU for controlling operation of a fan; and

FIG. 5 is a flow chart illustrating an exemplary flow of a cooling process performed by the cooling ECU.

### DETAILED DESCRIPTION OF EMBODIMENTS

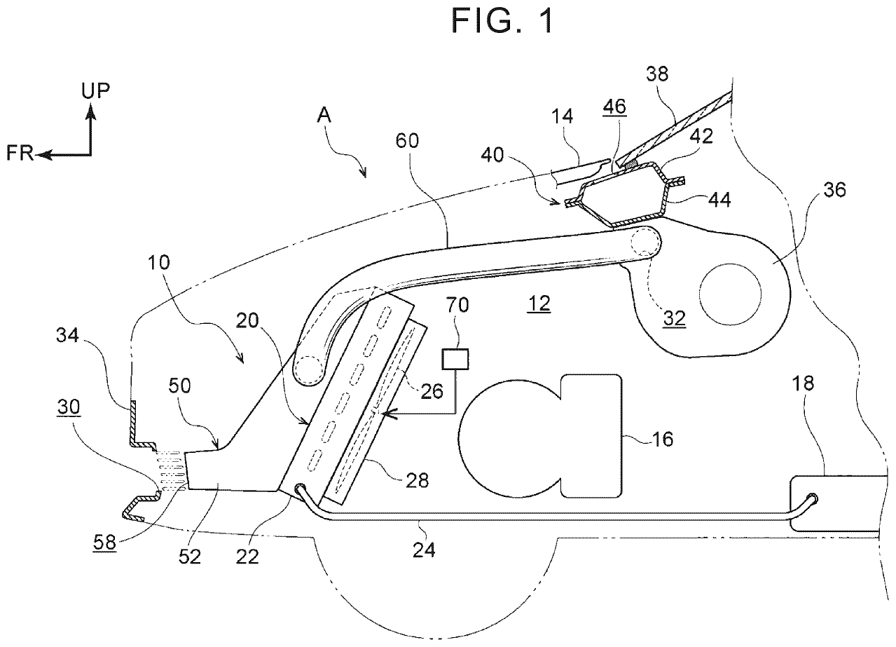

Hereinafter, the cooling structure 10 of the vehicle according to the present embodiment will be described with reference to FIGS. 1 to 5. Note that an arrow FR appropriately shown in the drawings indicates a vehicle front side, an arrow UP indicates a vehicle upper side, and an arrow LH indicates a vehicle left side. Hereinafter, when terms indicating directions i.e., forward and rearward, upward and downward, and right and left are used in the description without any specification, these means forward and rearward in the vehicle front-rear direction, upward and downward in the vehicle up-down direction, and right and left as seen in the traveling direction of the vehicle.

FIG. 1 is a side view of a front portion of a vehicle A to which a cooling structure 10 is applied as viewed from a left side. First, a front portion of the vehicle A to which the cooling structure 10 is applied will be described, and then a specific configuration of the cooling structure 10 will be described.

As shown in FIG. 1, a power unit chamber 12 is provided at a front portion of the vehicle A. The upper side of the power unit chamber 12 is covered by a hood 14 in such a manner that it can be opened and closed (see FIG. 1). The rear end portion of the power unit chamber 12 in the vehicle front-rear direction is constituted by a dash panel (vehicle body passenger compartment front wall) that separates the vehicle A from the vehicle cabin.

A power unit 16 that generates a driving force for the vehicle A to travel is mounted in the power unit chamber 12. The power unit 16 includes, for example, a device unit in which an inverter, an electric motor, and a transaxle are integrally formed. The inverter converts a direct current flowing from the battery 18 into a three-phase alternating current. The electric motor rotates by three-phase alternating current supplied from the inverter. The transaxle includes a transmission that is connected to a rotation shaft of the motor and changes the rotation of the motor, and a differential gear that distributes a driving force to the left and right tires. That is, the vehicle A according to the present embodiment is a battery electric vehicle (EV vehicle that travels using the electric power of the battery as a driving source).

The battery 18 is mounted on the vehicle rear side of the power unit chamber 12 at a substantially central portion in the front-rear direction of the vehicle A. A vehicle cabin (not shown) of the vehicle A is provided above the battery 18. The battery 18 is connected to the radiator 20 via a cooling medium pipe 24 which will be described later.

A radiator 20 as a heat exchanger is mounted on the vehicle front side of the power unit 16. The radiator 20 is a heat exchanger that cools the battery 18 by circulating coolant as a cooling medium with the water-cooled battery 18.

The radiator 20 is formed in a substantially rectangular box shape and includes a radiator body 22 and a cooling medium pipe 24 supported by the radiator body 22. The radiator body 22 is a frame formed in a rectangular shape when viewed in the vehicle front-rear direction. The radiator body 22 supports a cooling medium pipe 24 that meanders to reciprocate a plurality of times in the vehicle width direction. A plurality of fins (not shown) is attached to the cooling medium pipe 24. During traveling of the vehicle A, the air introduced into the inside of the power unit chamber 12 through the first intake opening (grille opening) 30, which will be described later, passes between the fins, and the coolant (cooling medium) circulating inside the cooling medium pipe 24 is cooled. The cooling medium pipe 24 is connected to a cooling medium flow path formed inside the battery 18, and the coolant flowing through the cooling medium pipe 24 circulates between the radiator 20 and the battery 18. Accordingly, the battery 18 is cooled.

In the present embodiment, the radiator 20 is disposed so as to be inclined such that the upper end portion thereof is positioned closer to the vehicle rear side than the lower end portion thereof. That is, the radiator 20 is disposed in a posture inclined backward. Accordingly, the mounting posture of the radiator 20 is reduced, and even when the radiator 20 is mounted in front of the power unit 16, the height of the front portion of the vehicle A can be suppressed.

A fan 26 is disposed on the rear side of the radiator 20. The fan 26 is covered by a box-shaped shroud 28 connected to the rear surface of the radiator 20. The fan 26 is integrated with the radiator 20 and constitutes one device unit together with the radiator 20 and the shroud 28.

The fan 26 is, for example, an electric fan that rotates with rotation of an electric motor (not shown) as a driving force. The fan 26 generates an air flow (cooling air) passing through the radiator 20 by its operation. That is, the radiator 20 is configured such that the cooling air that exchanges heat with the coolant passes from the front side of the vehicle toward the rear side of the vehicle by the operation of the fan 26. The cooling air after heat exchange with the coolant is discharged to the lower side of the vehicle A through an opening (not shown) provided on the floor surface of the power unit chamber 12.

The fan 26 is electrically connected to a cooling ECU 70 serving as a control device. The cooling ECU 70 is configured to operate the fan 26 at the time of high load of the battery 18 to be cooled, and to shut down the fan 26 at the time of low load of the battery 18. A detailed configuration of the cooling ECU 70 will be described later.

### Cooling Structure

Next, the cooling structure 10 for guiding the cooling air for performing heat exchange with the cooling medium by the radiator 20 will be described in detail.

As shown in FIG. 1, the cooling structure 10 has a first intake opening 30 provided at the front end of the vehicle and a second intake opening 32 provided at another portion except the front end of the vehicle as an intake port for introducing outside air into the power unit chamber 12.

The first intake opening 30 is, for example, a grille opening provided in a front surface and a central portion of the vehicle. The grille opening is formed in a lower portion of the bumper cover 34 constituting the front end portion of the vehicle A, and is opened in the vehicle front direction. The opening width of the first intake opening 30 along the vehicle width direction is set to be equal to or greater than the width of the radiator 20 along the vehicle width direction.

As an example, the second intake opening 32 is provided in an indoor air-conditioning duct 36 connected to an indoor air conditioner (not shown) of the vehicle A. The indoor air-conditioning duct 36 is disposed in a space between a dash panel that separates the power unit chamber 12 from the vehicle cabin, and an instrument panel (not shown) that constitutes a front wall of the vehicle cabin. The indoor air-conditioning duct 36 is connected to an outside air port 46 formed in the cowl portion 40 and an indoor air-conditioning opening formed in the instrument panel. Therefore, outside air is introduced into the interior of the indoor air-conditioning duct 36 through the outside air port 46 of the cowl portion 40.

The cowl portion 40 is a plate-shaped member made of a sheet metal disposed between the rear end portion of the hood 14 and the front windshield 38. The cowl portion 40 extends in the vehicle width direction, and an end portion in the extending direction is connected to the left and right pillars (not shown). As an example, the cowl portion 40 includes a cowl upper 42 that supports a lower end portion of the front windshield 38, and a cowl lower 44 that is connected to an indoor air-conditioning duct.

The middle portion of the cowl upper 42 in the front-rear direction is joined to the lower end portion of the front windshield 38, and supports the front windshield 38 from the lower side. Further, the cowl upper 42 is provided with an outside air port 46 for introducing outside air into the cowl portion 40.

On the other hand, in the cowl lower 44, flanges are formed at the front end portion and the rear end portion, and the flanges are joined to flanges provided at the front end portion and the rear end portion of the cowl upper 42. The cowl lower 44 is convex toward the vehicle lower side and forms a groove portion extending in the vehicle width direction. The groove portion guides rainwater and the like entering from the outside air port 46 of the cowl upper 42 to the outside in the vehicle width direction and discharges the rainwater and the like to the vehicle lower side. The cowl lower 44 is provided with an opening (not shown) connected to the indoor air-conditioning duct 36. Air introduced into the cowl lower 44 side from the outside air port 46 of the cowl upper 42 is introduced into the interior of the indoor air-conditioning duct 36 through the opening of the cowl lower 44. Further, a part of the air introduced into the indoor air-conditioning duct 36 is introduced into the second duct portion 60 described later through the second intake opening 32.

In the present embodiment, the radiator 20 is disposed so as to face the first intake opening 30 provided at the front end portion of the vehicle A. Further, between the first intake opening 30 and the radiator 20, a first duct portion 50 for supplying the air introduced from the first intake opening 30 to the radiator 20 is disposed.

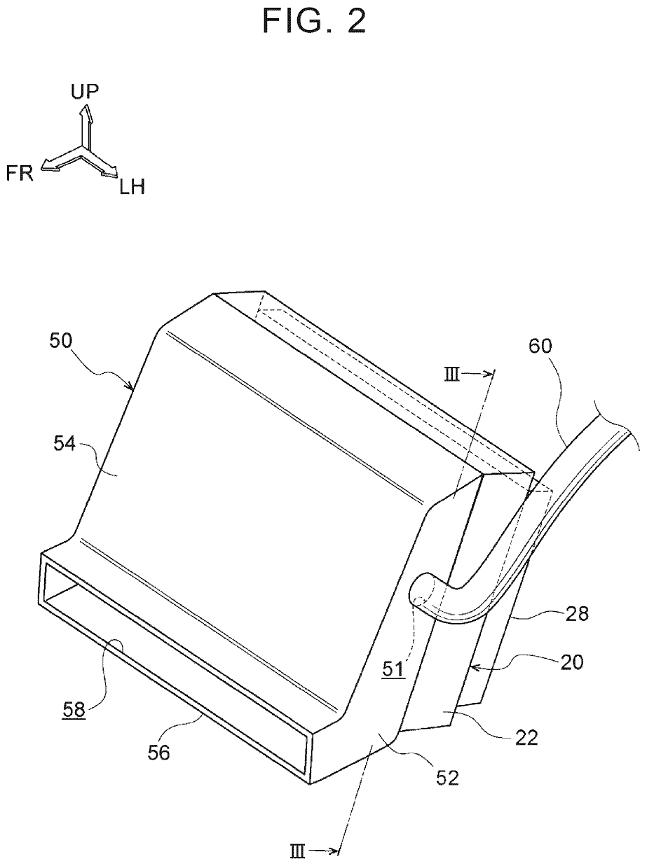

As shown in FIG. 2, the first duct portion 50 is attached to a front portion of the radiator 20. The first duct portion 50 is formed in a cylindrical shape extending from the radiator 20 toward the vehicle front side. Specifically, the radiator 20 includes a side wall portion 52 that stands forward from the left end portion and the right end portion, an upper wall portion 54 that connects the upper end portions of the side wall portion 52, and a lower wall portion 56 that connects the lower end portions of the side wall portion 52. A duct opening 58 that opens toward the vehicle front side is formed at a front end portion of the first duct portion 50. The opening width of the duct opening 58 along the vehicle width direction is set to be equal to the width of the radiator 20 along the vehicle width direction. Further, the opening width of the duct opening 58 along the vehicle vertical direction is set to be equal to or greater than that of the first intake opening 30.

In the present embodiment, from the viewpoint of protecting the radiator 20 at the time of collision of the vehicle front portion, the duct opening 58 and the first intake opening 30 are disposed so as to face each other in the vehicle front-rear direction in a state of being separated from each other. However, from the viewpoint of improving the cooling efficiency, the duct opening 58 may be connected to the first intake opening 30.

A connection opening 51 is formed in the side wall portion 52 of the first duct portion 50. One end of the second duct portion 60 is connected to the connection opening 51. In the present embodiment, the connection opening 51 is formed in the left side wall portion 52 of the first duct portion 50. The connection opening 51 is configured to be openable and closable by a flap portion 62 to be described later.

The second duct portion 60 is formed in an elongated cylindrical shape and connects the first duct portion 50 and the indoor air-conditioning duct 36. One end of the second duct portion 60 in the extending direction is connected to the side wall portion 52 of the first duct portion 50, and is arranged from the side in the vehicle width direction to the vehicle rear side of the radiator 20. The other end of the second duct portion 60 in the extending direction is connected to the indoor air-conditioning duct 36. Therefore, in the power unit chamber 12 of the vehicle A, the arrangement space of the second duct portion 60 is prepared on the side of the radiator 20. Therefore, it is not necessary to secure a space under the hood 14 for the second duct portion 60, and a design in which the height of the hood 14 is suppressed is possible.

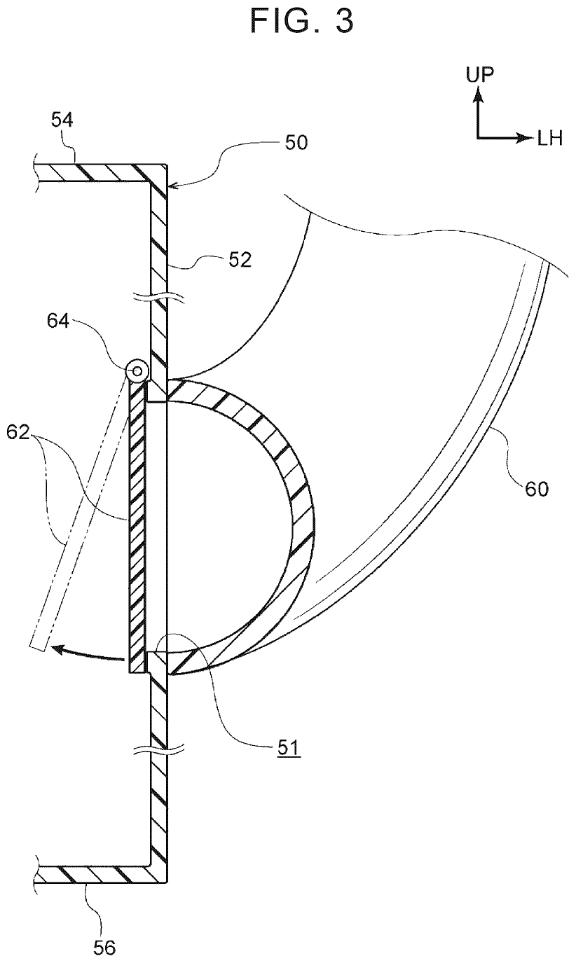

As shown in FIG. 3, the flap portion 62 is attached to the inner surface of the side wall portion 52 of the first duct portion 50 via a hinge portion 64. Thus, the flap portion 62 is configured to be rotatable about the hinge portion 64. The flap portion 62 closes the connection opening 51 by the action of the ram pressure of the traveling wind while the vehicle A is traveling. That is, during traveling, the traveling wind is introduced into the first duct portion 50 through the first intake opening 30. Due to the ram pressure of the traveling wind, the flap portion 62 is pressed against the side wall portion 52, and the connection opening 51 is closed.

On the other hand, when the fan 26 is operated when the vehicle A is stopped or the like, the flap portion 62 opens the connection opening 51 as indicated by a two-dot chain line in FIG. 3. That is, since the second duct portion 60 communicates with the second intake opening 32, the internal pressure is set to be equal to the outside air pressure (atmospheric pressure). On the other hand, when the air in the first duct portion 50 is sucked toward the rear side of the radiator 20 by the operation of the fan 26, the pressure in the first duct portion 50 is lower than the outside air pressure. As a result, the pressure in the first duct portion 50 becomes negative with respect to the pressure in the second duct portion 60, so that the flap portion 62 is opened and the connection opening 51 is opened.

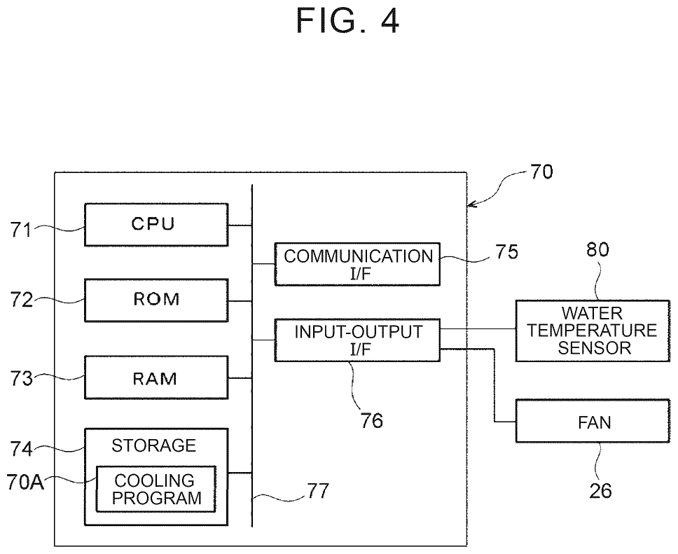

As described above, the fan 26 is electrically connected to a cooling ECU 70 serving as a control device, and is controlled to rotate an electric motor serving as a drive source at a predetermined rotational speed based on a signal from the cooling ECU 70. FIG. 4 is a diagram illustrating a hardware configuration of the cooling ECU.

As shown in FIG. 4, the cooling ECU 70 includes CPU (Central Processing Unit) 71, ROM (Read Only Memory) 72, RAM (Random Access Memory) 73, storages 74, communication I/F (interfaces) 75, and input/output I/F 76. CPU 71, ROM 72, RAM 73, the storage 74, the communication I/F 75, and the input/output I/F 76 are communicably connected to each other via a bus 77.

CPU 71 is a central processing unit that executes various programs and controls each unit. That is, CPU 71 reads the program from ROM 72 or the storage 74, and executes the program using RAM 73 as a working area. In the present embodiment, the cooling program 70A is stored in the storage 74.

ROM 72 stores various programs and various data. RAM 73 temporarily stores a program/data as a working area. The storage 74 is constituted by HDD (Hard Disk Drive), SSD (Solid State Drive), or a flash memory, and stores various programs including an operating system and various types of data.

The communication I/F 75 is an interface for connecting to other devices, and standards such as Ethernet (registered trademark) and FDDI, Wi-Fi (registered trademark) are used, for example. The input/output I/F 76 are interfaces for connecting to other ECU or other devices mounted on the vehicles A. In the present embodiment, a water temperature sensor 80 that detects the temperature of the coolant circulating in the battery 18 is connected to the input/output I/F 76. A fan 26 is connected to the input/output I/F 76.

The cooling ECU 70 reads the cooling program 70A stored in the storage 74 and executes a cooling process. In the cooling process, the operation of the fan 26 is controlled based on the detection value of the water temperature sensor 80. Specifically, the cooling ECU 70 activates the fan 26 when the coolant temperature exceeds the threshold T1 (° C.) based on information from the water temperature sensor 80 that detects the coolant temperature. The cooling ECU 70 is adapted to shut down the fan 26 when the coolant temperature falls below a second threshold T2 (° C.) that is less than or equal to the first threshold T1. In other words, this control can be regarded as a control for operating the fan 26 when the load (heat generation) on the cooling capacity in a state in which the fan 26 is not operated is high.

### Cooling Process

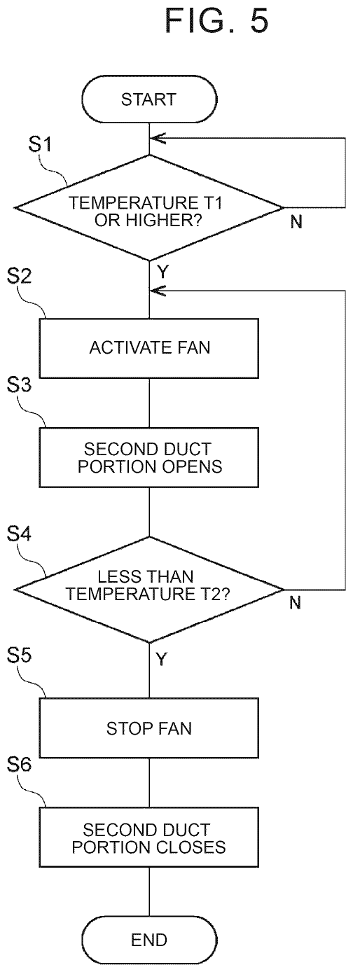

FIG. 5 is a flow chart illustrating an exemplary flow of a cooling process performed by the cooling ECU 70. The cooling treatment is performed at a predetermined cycle, for example, when the ignition switch of the vehicle A is turned ON. The cooling process is performed by CPU 71 reading out the cooling program 70A from ROM 72 or the storage 74, expanding it into a RAM 73, and executing it.

As illustrated in FIG. 5, the cooling ECU 70 determines whether or not the coolant temperature is equal to or higher than the threshold T1 (° C.) based on data from the water temperature sensor 80 that detects the coolant temperature inside the battery 18 (S1). Then, the cooling ECU 70 activates the fan 26 of the radiator 20 when it is determined that the coolant temperature is equal to or higher than the threshold T1 (° C.) (S2). On the other hand, when it is determined that the coolant temperature is lower than the threshold T1 (° C.), the cooling ECU 70 returns to S1 process.

When the fan 26 of the radiator 20 is operated, the pressure in the first duct portion 50 becomes negative pressure with respect to the inside of the second duct portion 60, and the flap portion 62 is opened (S3). Accordingly, the second duct portion 60 is opened, and the air introduced into the first duct portion 50 through the second intake opening 32 is supplied.

Next, the cooling ECU 70 determines whether or not the coolant temperature is less than the threshold T2 (° C.) based on the data from the water temperature sensor 80 that detects the coolant temperature inside the battery 18 (S4). Then, the cooling ECU 70 stops the fan 26 of the radiator 20 when it is determined that the coolant temperature is less than the threshold T2 (° C.) (S5). On the other hand, when it is determined that the coolant temperature is equal to or higher than the threshold T2 (° C.), the cooling ECU 70 returns to S2 process.

When the fan 26 of the radiator 20 is stopped, the pressure in the first duct portion 50 returns, and the flap portion 62 is closed by the ram pressure of the traveling wind introduced through the first intake opening 30 (S6). Thus, the second duct portion 60 is closed, and only the air introduced from the first intake opening 30 is guided into the first duct portion 50. Even when the vehicle that does not receive the traveling wind is stopped, the pressure in the first duct portion 50 and the pressure in the second duct portion 60 become substantially equal (i.e., equal to the outside air pressure) in a state in which the fan 26 is stopped. Therefore, even in this case, the flap portion 62 is configured to be closed by its own weight.

The cooling ECU 70 ends the cooling process after the fan 26 of the radiator 20 is stopped.

### Action and Effect

As described above, in the cooling structure 10 of the vehicle A according to the present embodiment, the air flow introduced into the first duct portion 50 through the first intake opening 30 provided at the front end portion of the vehicle A is guided to the radiator 20 as cooling air by the traveling of the vehicle A and the operation of the fan 26. Further, the air flow introduced into the second duct portion 60 through the second intake opening 32 provided in the other portion except the vehicle front end portion merges into the first duct portion 50, and is guided to the radiator 20 as cooling air. The second duct portion 60 is provided so as to be branched from the first duct portion 50, and the amount of air supplied to the radiator 20 through the first duct portion 50 can be increased. Therefore, the cooling efficiency of the main cooling flow path can be effectively increased, and the opening area of the first intake opening 30 can be easily reduced. This makes it possible to reduce the restriction on the design of the front end portion of the vehicle.

Further, in the present embodiment, the second intake opening 32 is provided in the indoor air-conditioning duct 36 connected to the cowl portion 40 disposed between the rear end portion of the hood 14 and the front windshield 38. The cowl portion 40 and the indoor air-conditioning duct 36 are conventionally provided in an existing vehicle as a flow path for introducing outside air into the vehicle cabin. For this reason, for example, an existing opening for introducing outside air can be adopted as the second intake opening 32, so that the change to the vehicle body is small and the operation can be easily performed.

Further, in the present embodiment, the second duct portion 60 is connected to the side surface of the first duct portion 50 in the vehicle width direction. Therefore, the second duct portion 60 can be arranged on the side of the radiator 20, and it is not necessary to secure the arrangement space of the second duct portion 60 in the upper space in the power unit chamber 12. Accordingly, it is possible to adopt a design in which the hood 14 of the vehicle body is lowered, and it is possible to reduce restrictions on the design of the front portion of the vehicle including the hood 14.

Further, in the present embodiment, the fan 26 is provided on the vehicle rear side of the radiator 20, and the air supplied to the radiator 20 via the first duct portion 50 is discharged to the vehicle rear side after heat exchange by the operation of the fan 26. Here, the connection opening 51 of the first duct portion 50 is connected to the second duct portion 60, the first duct portion 50, the flap portion 62 capable of opening and closing the connection opening 51 is provided. The flap portion 62 is opened by the operation of the fan 26 and closed by the stoppage of the fan 26. Therefore, in other words, when the fan is stopped, the heat exchanger is cooled by the air introduced from the first intake opening, and when the fan is operated, the heat exchanger can be cooled by the air introduced from the first intake opening and the second intake opening. Thus, for example, when it is necessary to increase the air volume of the cooling air, such as a case where sufficient traveling air cannot be obtained while the vehicle is stopped or a case where the fan is operated by the heat generation of the cooling target, it is possible to increase the air volume of the cooling air. On the other hand, in a case where sufficient traveling wind is obtained during traveling or the like, it is possible to suppress a decrease in aerodynamic performance during traveling by interrupting the introduction of air from the second duct portion.

Further, since the opening of the flap portion 62 is enabled by the pressure difference between the inside of the first duct portion 50 and the inside of the second duct portion 60, the flap portion can be opened and closed without using an electric actuator or the like. Therefore, the power consumption of the vehicle A can be suppressed.

The radiator 20 is connected to the battery 18 via a cooling medium pipe 24. Therefore, according to the present embodiment, it is possible to reduce the restriction on the design of the front end portion of the vehicle A while improving the cooling efficiency of the battery 18 by the radiator 20.

### Supplementary Explanation

Although an embodiment of the present disclosure has been described above, the embodiment of the present disclosure is not limited thereto, and can be modified without departing from the gist of the present disclosure. For example, although the embodiments described above have been applied to a battery electric vehicle (EV vehicle), the present disclosure is not limited thereto. Hybrid electric vehicle (HV vehicles), plug-in hybrid electric vehicle (PHEV vehicles), fuel cell electric vehicle (FCV vehicles) and the like may be used in the cooling structure for the battery.

Further, in the present disclosure, the cooling target of the radiator 20 as a heat exchanger is not limited to a battery. It is applicable to various OBE. For example, a condenser constituting a refrigeration cycle of an indoor air conditioner or an engine as an internal combustion engine may be used as a cooling target. That is, the cooling structure according to the present disclosure may be applied to a vehicle including an engine as an internal combustion engine. In this case, the power unit mounted in the power unit chamber may be constituted by an engine and a transformer wheel.

Further, the connection destination of the other end of the second duct portion 60 is not limited to the indoor air-conditioning duct 36. For example, the other end of the second duct portion 60 may be directly connected to the outside air port 46 of the cowl portion 40. That is, the second intake opening 32 may be constituted by the outside air port 46 of the cowl portion 40. Further, the second intake opening 32 is not limited to the embodiment formed in the vicinity of the cowl portion 40. For example, the second intake opening may be provided in a part of the outer plate constituting the vehicle width direction side portion of the vehicle body as long as the part excluding the front end portion of the vehicle A is sufficient.

Further, in the above-described embodiment, the configuration of the flap portion that enables the connection opening of the first duct portion to be opened and closed is not essential. That is, the flap portion may be omitted, and the second duct portion may be opened to the first duct portion at all times.

What is claimed is:

1. A cooling structure for a vehicle, the cooling structure comprising:
a first intake opening provided at a vehicle front end;
a second intake opening provided in a different portion other than the vehicle front end;
a heat exchanger that is disposed rearward of the first intake opening in a vehicle front-rear direction and that is cooled by heat exchange with air;
a first duct portion that is disposed between the first intake opening and the heat exchanger and that supplies air introduced from the first intake opening to the heat exchanger; and
a second duct portion that branches off from the first duct portion, that connects the second intake opening and the first duct portion, and that supplies air introduced from the second intake opening to the first duct portion.

2. The cooling structure according to claim 1, wherein the second intake opening is provided in a cowl portion disposed between a rear end of a hood and a front windshield, or in an indoor air-conditioning duct connected to the cowl portion.

3. The cooling structure according to claim 1, wherein the second duct portion is connected to a side surface in a vehicle width direction of the first duct portion.

4. The cooling structure according to claim 1, further comprising:
a fan that is provided rearward of the heat exchanger in the vehicle front-rear direction, and that discharges the air supplied to the heat exchanger via the first duct portion toward a rear of the vehicle; and
a flap portion configured to open and close a connection opening of the first duct portion that is connected to the second duct portion, wherein the flap portion is configured to open when a pressure in the first duct portion becomes negative with respect to a pressure in the second duct portion by operation of the fan.

5. The cooling structure according to claim 1, wherein:
an object to be cooled by the heat exchanger is connected to the heat exchanger via a cooling medium pipe; and
the object to be cooled is a battery mounted on the vehicle.
